(19) United States
(12) Patent Application Publication
(10) Pub. No.: US 2010/0044929 A1
(43) Pub. Date: Feb. 25, 2010

(54) METHOD OF FORMING A SPARK PLUG INSULATOR

(76) Inventor: Jeffrey Boehler, Holland, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/546,917

(22) Filed: Aug. 25, 2009

Related U.S. Application Data
(60) Provisional application No. 61/091,560, filed on Aug. 25, 2008.

(51) Int. Cl. B29C 45/72; H01T 21/02

(52) U.S. Cl. 264/645; 445/7

(57) ABSTRACT

Exemplary embodiments of the present invention provide methods for forming spark plug insulators, particularly asymmetrical spark plug insulators, without required machining after an initial heating or firing of the spark plug insulator. In one exemplary embodiment, a method of forming an asymmetrical spark plug insulator is. The method includes: forming a first mixture comprising a binder formed of water and agar; forming a second mixture comprising a ceramic material; combining the first mixture and the second mixture to form a molding compound; injection molding the molding compound to form an asymmetrical spark plug insulator having a initial net shape and size; and sintering the asymmetrical spark plug insulator to cause hardening of the asymmetrical spark plug, the sintered asymmetrical spark plug having a final net shape and size.

### CROSS REFERENCE TO RELATED APPLICATION

The present application claims the benefit of U.S. Provisional Patent Applications, Ser. Nos. 61/091,560, filed Aug. 25, 2008, the contents each of which are incorporated herein by reference thereto.

### FIELD OF THE INVENTION

Exemplary embodiments of the present invention provide methods for forming spark plug insulators, particularly asymmetrical spark plug insulators, without required machining after an initial heating or firing of the spark plug insulator.

### BACKGROUND

Insulators for spark plugs are typically molded of ceramic material and sintered to form a hardened and durable component. Upon initial heating or firing, such as through a bisque firing process or the like, openings are drilled or otherwise formed in the insulators for locating the insulators with respect to a machining device. The insulators are then machined, such as through a spindle based machining process or otherwise, to specified dimensions. Certain molding techniques, particularly techniques using waxed based binders or the like, require over molding of the insulator to ensure sufficient material is available for machining the insulator upon initial heating. This is due to the removal or evaporation of the binder material during the heating process. However, the additional step of machining is time consuming and costly. This is particularly so with respect to insulators that are complex in shape, such as asymmetrically shaped spark plug insulators. In another aspect, the use of traditional binders often results in early wear of the forming dies due to friction between the molding material and the die. This wear leads to costly replacement of such dies. Accordingly, there is a need for an improved method of forming a spark plug insulator, particularly an asymmetrically shaped spark plug insulator, having reduced forming time and manufacture cost.

### SUMMARY OF THE INVENTION

Exemplary embodiments of the present invention provide methods for forming spark plug insulators, particularly asymmetrical spark plug insulators, without required machining after an initial heating or firing of the spark plug insulator. In one exemplary embodiment, a method of forming an asymmetrical spark plug insulator is required. The method includes: forming a first mixture comprising a binder formed of water and agar; forming a second mixture comprising a ceramic material; combining the first mixture and the second mixture to form a molding compound; forming an asymmetrical spark plug insulator with the molding compound through injection molding, the asymmetrical spark plug having a initial net shape and size; and sintering the asymmetrical spark plug insulator to cause hardening of the asymmetrical spark plug, the sintered asymmetrical spark plug having a final net shape and size.

In another exemplary embodiment, a method of forming a dual-electrode spark plug, for an engine, is provided. The method includes: forming an asymmetrical spark plug insulator from a molding compound comprising a ceramic and a binder formed of water and agar through injection molding, the asymmetrical spark plug insulator including: a pre-chamber, a first opening extending from the pre-chamber and a second opening extending from the pre-chamber; sintering the asymmetrical spark plug insulator; disposing a first electrode within the first opening and a second electrode within the second opening; and disposing the asymmetric spark plug insulator within an outer shell having a ground electrode in electrical communication with the first and second electrodes, wherein after sintering the method of forming the dual-electrode spark plug is substantially free of a machining process to the asymmetrical spark plug insulator.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 illustrates a flow chart illustrating a method of forming an asymmetric spark plug insulator according to an exemplary embodiment of the present invention;

FIG. 2 illustrates a cross-sectional view of an asymmetric spark plug insulator formed according to the teachings of the present invention;

FIG. 3 illustrates an end view of the asymmetric spark plug insulator shown in FIG. 2;

FIG. 4 illustrates another end view of the asymmetric spark plug insulator shown in FIG. 2; and

FIG. 5 illustrates a cross-sectional view of spark plug according to an exemplary embodiment of the present invention.

### DETAILED DESCRIPTION OF EXEMPLARY EMBODIMENTS

Exemplary embodiments of the present invention provide methods of forming spark plug insulators, particularly spark plug insulators having complex shapes such as asymmetrically shaped spark plug insulators. The advancements of the present invention are predicated upon the use of binding agents having improved properties such as reduction in material shrinkage during a heating or sintering process. This advancement allows net shape spark plug insulators to be formed without accommodation of shape or size reduction during the forming process. More so, this allows for the spark plug insulators to be formed to a specified shape and size, with little to no necessary machining upon forming. Another improved property comprises friction reducing capabilities of the binder during forming of the spark plug insulator. This friction reducing capability improves die life of the forming device. Other advantageous features will become apparent as shown and described herein.

In one exemplary embodiment, the features of the present invention are derived through the used of a binder comprising an agar mixture, such as water/agar mixture. In contrast to prior binders used for forming asymmetrical spark plug insulators, such as waxed based binder, polyethylene binder or otherwise, the agar binder of the present invention is resistant to shrinkage during drying or heating, thereby substantially preventing shrinkage of the spark plug insulators during an initial heating, such as a bisque firing process or otherwise. Traditionally, the formation of asymmetrically shaped spark plug insulators utilize an over molding process followed by an initial heating, such as bisque firing, and machining to form the final spark plug insulator shape and size. Now, with the binder of the present invention, the spark plug can be formed to net shape and size and sintered without secondary operation such as machining. This is due to the binder's excellent dimensional stability which allows sintering to net shape. Such machining may include cutting, drilling, grinding or otherwise to change the final shape of the object to render it usable for its intended purpose. Also, the agar binder of the present invention provides friction reducing capabilities for improving forming speed and quality of the spark plug insulator, as well as prolonging service life of the forming dies. Still further, the agar binder provides high green strength capability of the spark plug insulator for handling prior to sintering.

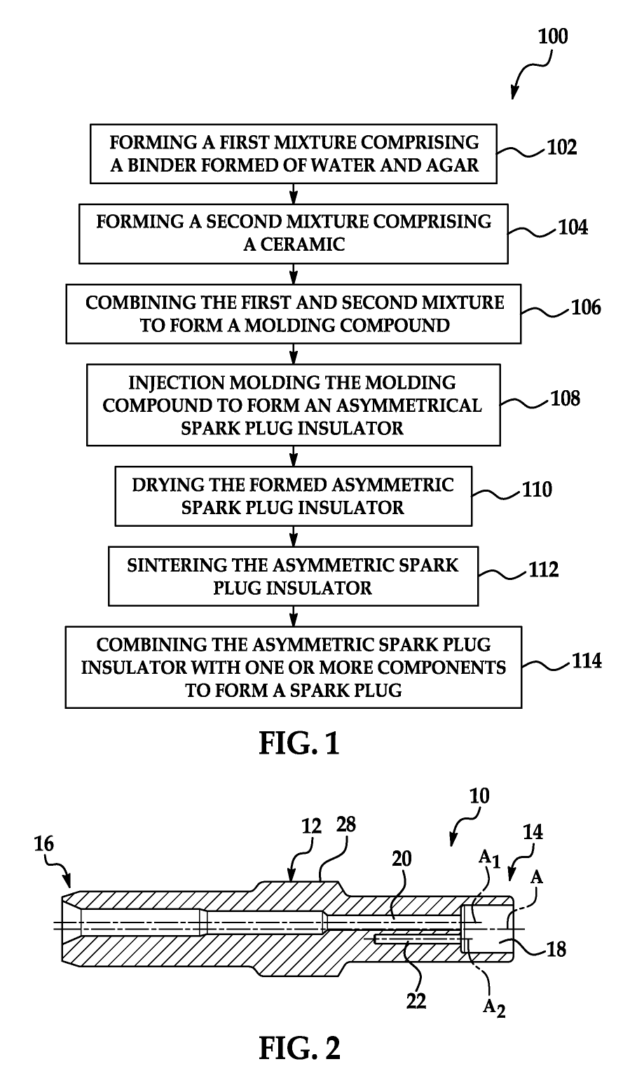

In general, referring to FIG. 1, an exemplary embodiment of a forming method of an asymmetrical spark plug insulator 100 is shown and described. The process includes forming a first mixture comprising a binder formed of water (or other solvent) and agar 102. The process also includes forming a second mixture comprising ceramic 104 or a mixture thereof. The first and second mixtures are combined to form a molding compound 106. The molding compound is injection molded to form an asymmetrical spark plug insulator 108. The asymmetrical spark plug insulator is dried 110 and sintered to form a hardened component 112, wherein the net shape and size of the asymmetrical spark plug insulator remains substantially unchanged. Optionally, the asymmetric spark plug insulator is combined with other components to form a spark plug assembly 114.

In greater detail, with respect to forming the first mixture 102, in one exemplary embodiment the binder used for forming the asymmetrical spark plug insulator includes an agar and a solvent, which is combinable to form a gelatinous-like substance. The agar is derived from seaweed, such as that comprising an unbranched polysaccharide obtained from the cell membranes of some species of red algae. Examples of suitable agar binders can be found in U.S. Pat. No. 5,286,767, to Rohrbach et al, and U.S. Pat. No. 5,397,520, also to Rohrbach et al, the contents of both are hereby incorporated by reference for all purposes. The use of such gel-forming materials substantially reduces the amount of binder needed to form a self-supporting article due to its inherent binding capabilities and friction reducing characteristics. Thus, articles produced by using gel-forming materials can significantly enhance the production of net shape and near net shape objects.

Forming the first mixture 102 further includes the addition of a solvent sufficient to dissolve the agar material. While a variety of solvents may be used, a particularly useful solvent comprises polyhedric liquids, particularly polar solvents such as water or alcohols, liquids such as carbonates or amides or any mixtures thereof. In one exemplary embodiment, the solvent performs a dual function of acting as a solvent for the agar and forming a carrier for the agar mixture, thus enabling the mixture to be easily supplied to a mold. It has been discovered that water is particularly suited for serving the dual purpose noted above. In addition, because of its low boiling point, water is easily removed from the self-supporting body prior to and/or during a sintering process. Upon selection of a suitable combination forming the first mixture 102, the appropriate amount of agar and solvent is weight and mixed together to form the first mixture. However, it should be appreciated that other components may be added to form the first mixture, such as those described herein.

With respect to formation of a second mixture 104, a ceramic mixture including one or more ceramic materials is formed. The ceramic material may include any suitable ceramic material which may be in combination with other materials such as metal or otherwise. In one exemplary embodiment, the ceramic material comprise powder formed of one or more oxides, borides, nitrides, silicides and carbides of metals, nonmetals, combinations thereof or otherwise. In one particular exemplary embodiment, the ceramic comprises alumina and may include fully and/or partially stabilized Zirconia. Examples of suitable materials for use for forming the ceramic second mixture can also be found in U.S. Pat. Nos. 5,286,767 and 5,397,520. Upon selection of a suitable combination forming the second mixture 104, the appropriate amount of ceramic, or specific ingredients thereof, is weight and mixed together to form the first mixture. However, it should be appreciated that other components may be added to form the first mixture, such as those described herein. In one exemplary embodiment, the resulting second mixture is pre-formed into bits, pellets, the like or otherwise, prior to forming the molding compound.

As previously mentioned, the first mixture, second mixture or resulting molding compound may include additional components for improving formation of the spark plug insulator. For example, the first and/or second mixture may contain additives which can serve any number of useful purposes. For example, dispersants (e.g., Darvan C) may be employed to ensure a more homogeneous mixture. Lubricants such as glycerine may be added to assist in feeding the mixture along the bore of an extruder barrel and additives such as glycerine to reduce the vapor pressure of the liquid carrier and enhance the production of the near net shape objects. The amount of additives will vary depending on the additive and its function within the system. Other additives are possible such as those found in found in U.S. Pat. Nos. 5,286,767 and 5,397,520 or otherwise.

The first and second mixtures are combined and mixed to form a molding compound 106. The combination of the ingredients to form the molding compound may be achieved in any suitable manner. Similarly, mixture of the ingredients may be achieved in any suitable manner. For example, in one exemplary embodiment (not shown), a receptacle is provided for receiving the first and second mixture. The receptacle includes a mixing device for mixing the first and second ingredients to form the molding compound. The molding compound is transferrable to a molding device through a suitable fluid connection formed between the receptacle and the molding device. It should be appreciated that other configurations are possible.

The molding compound is formed into an asymmetrical spark plug insulator 108 through a molding device (not shown). The molded spark plug insulator includes an initial net shape and size and sufficient green strength to allow for handling. The molding device may comprise any suitable molding device. In one exemplary embodiment, the molding device comprises ceramic injection molding device (not shown). Suitable ceramic injection molding device are available through BOY at http://www.boymachines.com and HPM Hemscheidt at http://www.hpm-hemscheidt-service.de/Start_english/Contact/contact.html.

Upon molding of the asymmetrical spark plug insulator, the insulator is removed from the mold and dried 110. Again, due to the material characteristics of the binder, particularly when combined with the ceramic, the asymmetrical spark plug insulator includes sufficient green strength to allow for handling of the insulator, either before or after drying. Further, the resulting green strength of the spark plug insulator eliminates the need of any initial heating or bisque firing process. In one exemplary embodiment, drying time of the formed spark plug insulator may range from about 1 to 10 hours, or less. However, it is contemplated the drying time of the insulator may be reduced through a suitable heating device.

Upon drying, the insulator is sintered to cause hardening of the insulator 112. The sintered spark plug insulator includes a final net shape and size. Sintering of the spark plug insulator may include the use of any suitable sintering device and process. For example, suitable sintering devices includes any suitable kiln capable of reaching temperatures of about 1500° C. to 2000° C. The time required for sintering may vary, depending on the configuration (e.g., size, shape, material or otherwise) of the spark plug insulator. As previously mentioned, in one exemplary embodiment the final net shape and size of the spark plug insulator is substantially identical to the initial net shape and size formed by the mold and as prescribed by the design constraints required for the spark plug insulator.

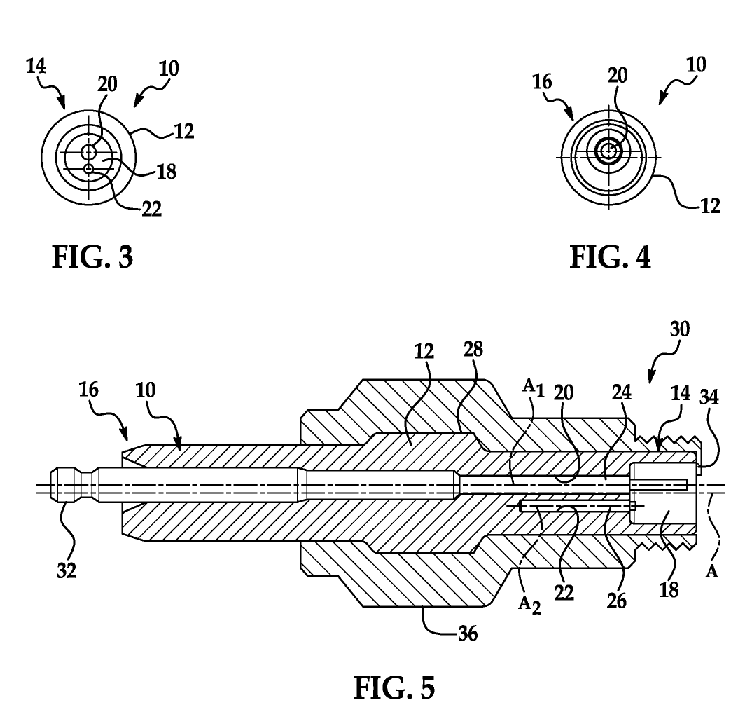

In view of the foregoing, referring to FIGS. 2-4, an exemplary embodiment of an asymmetric spark plug insulator 10 is shown formed through the forming method as described herein. The insulator includes a body 12 extending between a first end 14 configured for placement within or proximate to a combustion chamber of and engine (not shown) and a second 16 configured for providing support to an electrical connector or electrode. In this configuration, the first end 14 of the insulator 10 includes a pre-chamber for generating a spark, and hence combustion, therein. This is particularly advantageous for certain engine configurations requiring addition flame propagation within a combustion chamber. The insulator 10 further includes first opening 20 for receiving a first electrode 24 (see FIG. 5) and a second opening 22 for receiving a second electrode 26 (see FIG. 5).

In general, a spark plug insulator is considered asymmetrical in shape when the internal through hole (such as first opening 20) is not on the part centerline or axis ‘A’ or when an external feature of part is eccentric to the part centerline or axis. One non-limiting example of an asymmetrical spark plug and spark plug insulator is found in U.S. Patent Publication No. US 2006/0267469 the contents of which are incorporated herein by reference thereto. As discussed above, for these types of asymmetrical shaped parts the conventional isostatically formed ceramic blank and spindle based machining process cannot be used to manufacture the internal and external insulator features. Therefore, extra processing steps are required to manufacture the spark plug ceramic insulator using an isostic powder based process.

Referring again to FIG. 2, the asymmetrical spark plug insulator 10 includes a center axis ‘A’ indicating a rough axis of symmetry or part centerline of the insulator body 12, with respect to the majority of an exterior surface 28 of the insulator body 12. The first opening 20 includes a first axis ‘A1’ and the second opening 22 includes a second axis ‘A2’. In this embodiment, the first axis ‘A1’ and the second axis ‘A2’ are displaced with respect to the center axis ‘A’ of the insulator 10 to form an asymmetrical spark plug insulator. Similarly, the first electrode 24 (see FIG. 5) and the second electrode 26 (see FIG. 5) are also disposed with respect to the center axis ‘A’ of the insulator. This configuration is particularly advantageous for forming a dual-electrode spark plug 30, as described herein.

Referring again to the method shown and described in FIG. 1, upon sintering, the method may further include combining the asymmetrically formed spark plug insulator with other components to form a spark plug 114. Referring to FIG. 5, an exemplary embodiment of a dual-electrode spark plug 30 is shown. The spark plug 30 includes an asymmetrical spark plug insulator 10, as described herein. The spark plug 30 includes first electrode 24 extending with first opening 20 and a second electrode 26 extending within the second opening. The second electrode 26 is in electrical communication with an electrical terminal 32 extending partially within the first opening 20 and from the second end 16 of the insulator 10. The second electrode is also in electric communication with the first electrode 24 and a ground electrode 34, via the first electrode. The ground electrode 34 extends inwardly from an outer shell 36 configured to attach the spark plug to an engine (not shown). In operation, electric current is transmitted to the second electrode 26 through the electrical terminal 32. As a result, voltage is generated between the second electrode 26 and the first electrode 24, thereby forming a spark therebetween and within the pre-chamber 18 and igniting a air/fuel mixture therein. An additional spark is formed between the first electrode 24 and ground electrode 34 resulting in further ignition of an air/fuel mixture within the engine chamber.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A method of forming an asymmetrical spark plug insulator, comprising:
forming a first mixture comprising a binder formed of water and agar;
forming a second mixture comprising a ceramic material;
combining the first mixture and the second mixture to form a molding compound;
forming an asymmetrical spark plug insulator with the molding compound through injection molding, the asymmetrical spark plug having an initial net shape and size; and
sintering the asymmetrical spark plug insulator to cause hardening of the asymmetrical spark plug, the sintered asymmetrical spark plug having a final net shape and size.

2. The method of claim 1, wherein the initial net shape and size is substantially identical to the final net shape and size of the asymmetrical spark plug insulator.

3. The method of claim 2, wherein the method of forming the asymmetrical spark plug insulator is substantially free of a machining process.

4. The method of claim 1, further comprising the step of drying the asymmetrical spark plug insulator after injection molding and prior to sintering.

5. The method of claim 1, wherein upon injection molding the asymmetrical spark plug insulator is sufficient in green strength to allow for handling.

6. The method of claim 1, wherein the resulting asymmetrical spark plug insulator forms a pre-chamber.

7. The method of claim 6, wherein the resulting asymmetrical spark plug insulator forms a first opening extending from the pre-chamber and a second opening extending from the pre-chamber, each of the first opening and the second opening having an axis that is displaced from a center axis of the asymmetrical spark plug insulator.

8. A method of forming a dual-electrode spark plug for an engine, comprising:
forming an asymmetrical spark plug insulator from a molding compound comprising a ceramic and a binder formed of water and agar through injection molding, the asymmetrical spark plug insulator including: a pre-chamber, a first opening extending from the pre-chamber and a second opening extending from the pre-chamber;
sintering the asymmetrical spark plug insulator;
disposing a first electrode within the first opening and a second electrode within the second opening; and
disposing the asymmetric spark plug insulator within an outer shell having a ground electrode in electrical communication with the first and second electrodes, wherein the method of forming the asymmetrical spark plug insulator is substantially free of a machining process.

9. The method of claim 8, wherein upon injection molding the asymmetrical spark plug insulator includes an initial net shape and size and upon sintering the asymmetric spark plug insulator includes a final net shape and size, wherein the initial net shape and size is substantially identical to the final net shape and size.

10. The method of claim 8, further comprising the step of drying the asymmetrical spark plug insulator after injection molding and prior sintering.

11. The method of claim 8, wherein upon injection molding the asymmetrical spark plug insulator is sufficient in green strength to allow for handling.
